(19) United States
(12) Patent Application Publication
(10) Pub. No.: US 2008/0040759 A1
(43) Pub. Date: Feb. 14, 2008

(54) System And Method For Establishing And Maintaining Synchronization Of Isochronous Audio And Video Information Streams in Wireless Multimedia Applications

(76) Inventors: George Geeyaw She, Pittsford, NY (US); James Dean Allen, Greece, NY (US); James Charles Stoffel, Rochester, NY (US); Anthony Lawrence Tintera, Brockport, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/682,074

(22) Filed: Mar. 5, 2007

Related U.S. Application Data
(60) Provisional application No. 60/779,476, filed on Mar. 6, 2006.

(51) Int. Cl. H04N 7/18

(52) U.S. Cl. 725/81; 725/80; 725/74; 725/78

(57) ABSTRACT

A system and method for establishing and maintaining synchronization of isochronous audio and video information streams in wireless multimedia applications. The system includes a media source device capable of sending multimedia content a media consumer device capable of receiving said multimedia content, control signals that are exchanged between said media source device and said media consumer device, and an algorithm that uses the control signals to synchronize isochronous video and audio streams that pass between said media source device and said media consumer device. Some embodiments of the present invention include an algorithm to enable a device to have both the media sourcing and media consuming functions. The system and method includes algorithms that use the control signals to establish and maintain synchronization between the isochronous audio, data, and video streams of multimedia content, and, optionally, allows a device to both transmit and receive said multimedia content.

### CROSS-REFERENCE TO RELATED PATENT APPLICATIONS

This application claims the benefit of the filing date of U.S. Provisional patent application Ser. No. 60/779,476 filed on Mar. 6, 2006.

### BACKGROUND OF THE INVENTION

1. Field of the Invention

This invention relates generally to wireless multimedia systems, and more particularly to a system and method for establishing and maintaining synchronization of isochronous audio and video streams in a wireless multimedia system. Multimedia systems may be either video (motion or still), audio, data or combined video, audio, and data systems.

2. Description of Related Art

Home entertainment systems have traditionally included such components as television and stereo equipment. The various components of these systems are electrically coupled by way of wires and cables. In recent times, there has been a proliferation of equipment that makes up a home entertainment system. The modern home entertainment system has now become more of a multimedia system that includes a variety of elements such as set-top boxes, digital video recorders, media servers, televisions, high definition televisions, speakers, frequency modulated and satellite radio, personal computers, and the like. The growing complexity of today's home entertainment system places a burden on traditional hard-wired interconnects. Today's cable and wire interconnect systems are complex and often times lack the aesthetic attributes that are needed in a home environment. In addition, often times a home entertainment system may be distributed throughout the home, creating challenges to physical wiring techniques. There has also been a growing trend to integrate the world of personal computers, networking and the Internet with home entertainment systems. This trend has created additional demands on physical wiring techniques.

The physical wiring constraints of the personal computing environment are being addressed through wireless standards such as IEEE 802.11, as defined by the Institute of Electrical and Electronics Engineers, making access to the Internet or a local area network possible without the need for a physical wire. The use of wireless interconnects as a replacement for physical interconnects in a home entertainment system is also being considered through the development of standards such as IEEE 802.15.3. The use of wireless interconnects in an application such as a home entertainment system presents several technical challenges that must be overcome in order to deliver an acceptable quality level to the consumer. One technical challenge is the synchronization of audio and video streams as they are delivered to the consumer. In a wireless home entertainment system, audio and video content is transmitted as separate, independent isochronous data streams between the various components of the home entertainment system. However, the inherent characteristics of radio communications can adversely affect the quality of these isochronous data streams, causing undesirable situations such as the loss of synchronization between the audio and video signals. This loss of synchronization may manifest itself in events such as the lack of lip synchronization between audio from rear speakers and the video picture on a television or monitor, causing quality of service degradation that is unacceptable to the consumer. Wired entertainment systems do not generally have problems with quality of service and signal degradation. Unfortunately, the wiring of these systems does represent physical infrastructure challenges that are not present in wireless entertainment systems. Present wireless entertainment systems for consumer electronics applications have limited radio frequency (RF) bandwidth, such that information transfer must be minimized and reliability of the information transmitted cannot be assured. In most half-duplex radio systems, in which the transmitter and the receiver cannot be enabled simultaneously, often times collision of transmissions from different wireless devices cannot be avoided, resulting in loss of data. In order to allow multiple devices to access a wireless network, multiple-access protocols such as Time Division Multiple Access (TDMA), Code Division Multiple Access (CDMA), and Carrier Sense Multiple Access (CSMA) are used. The use of CSMA protocols in a real time environment such as a wireless home entertainment system based on the Institute of Electrical and Electronics Engineers (IEEE) standard 802.11 (also known as Wi-Fi) is problematic due to the inherent signal delays caused by the use of such contention protocols with statistically varying access. In addition to the use of multiple-access protocols, the path the radio frequency (RF) signal takes to get from its source to its various destinations also varies in a wireless entertainment system, resulting in delays caused by audio and video signals arriving at their respective destinations (such as speakers or a television) at different times. Furthermore, flow control and retransmissions may be invoked in the multiple access protocol when the radio frequency signals encounter interference, causing additional substantial delays and further degradation to the quality of service in a wireless home entertainment system.

It is therefore an object of the present invention to provide a system and method for establishing and maintaining synchronization between the Isochronous audio and video streams of wireless multimedia applications, in which the delivery of such data streams to their respective destination must be guaranteed within a fixed period of time. It is another object of the present, invention to provide a system and method for establishing and maintaining synchronization between the isochronous audio and video streams of wireless multimedia applications that are delivered to multiple receiving elements, it is another object of the present invention to provide a system and method for correcting synchronization drift in a wireless entertainment system. It is another object of the present invention to provide a system and method for establishing and maintaining synchronization of multicast audio or video streams wirelessly transmitted to multiple, specified destinations, such as single audio content that is being wirelessly transmitted to multiple and different channel speakers, or the same video content that is being wirelessly transmitted to multiple TV sets in different rooms. It is another object of the present invention to provide a system and method for enabling a device in a wireless multimedia system to have both media sourcing and media consuming functions.

### BRIEF SUMMARY OF THE INVENTION

A system for establishing and maintaining synchronization of isochronous audio and video information streams in wireless multimedia applications, the system comprising a media source device capable of sending multimedia content, a media consumer device capable of receiving said multimedia content, control signals that are exchanged between said media source device and said media consumer device, an algorithm that uses said control signals to synchronize isochronous video and audio streams that pass from said media source device to said media consumer device. In some embodiments of the present invention, the system may include an algorithm to enable a device to have both media sourcing and media consuming functions.

The foregoing paragraph has been provided by way of introduction, and is not intended to limit the scope of the various embodiments of the present invention as described in this specification and the claims contained herein.

### BRIEF DESCRIPTION OF THE DRAWINGS

The invention will be described by reference to the following drawings, in which like numerals refer to like elements, and in which:

FIG. 1 is a block diagram of a typical wireless home entertainment system.

FIG. 2 is a block diagram depicting an audio-video (AV) receiver having both Media Source Device (MSD) and Media Consumer Device (MCD) functions in a wireless home entertainment system.

FIG. 3 is a functional architecture diagram of a Media Source Device (MSD).

FIG. 4 is a functional architecture diagram of a Media Consumer Device (MCD).

FIG. 5 illustrates an example of starting up an audio-video application.

FIG. 6 is an example of a data frame structure.

FIG. 7 is a flow chart depicting the process of establishing and terminating synchronization.

FIG. 8 is a flow chart depicting the process of maintaining synchronization.

The present invention will be described in connection with a preferred embodiment; however, it will be understood that there is no intent to limit the invention to the embodiment described. On the contrary, the intent is to cover all alternatives, modifications, and equivalents as may be included within the spirit and scope of the invention as defined by this specification and the claims herein.

### DESCRIPTION OF THE PREFERRED EMBODIMENTS

For a general understanding of the present invention, reference is made to the drawings. In the drawings, like reference numerals have been used throughout to designate identical elements.

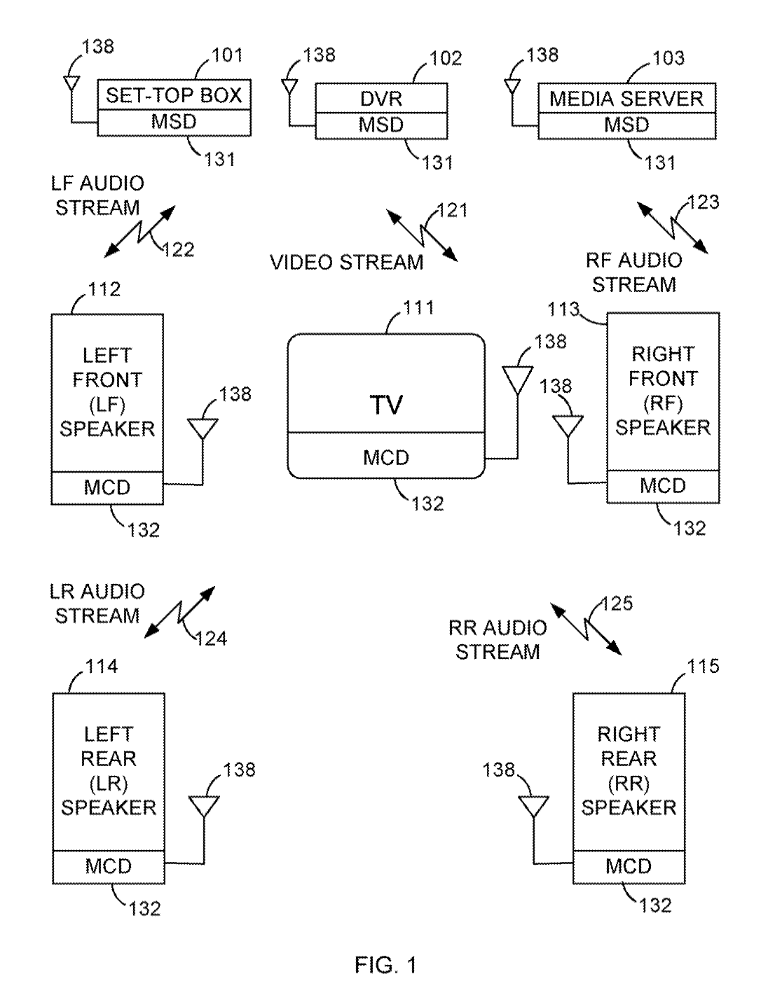

Referring to FIG. 1, a block diagram of a wireless home entertainment system is shown. The elements of the wireless home entertainment system depicted in FIG. 1 are provided by way of example, with changes to the elements being expected and known to those skilled in the art. These changes are not meant to be a departure from the spirit and scope of the various embodiments of the present invention as defined herein. In FIG. 1, a Set-Top Box (STB) 101, a Digital Video Recorder (DVR) 102 and a Media Server 103 are portrayed. These elements are examples of Media Source Devices (MSD) 131. A Media Source Device (MSD) 131 is defined as any element of a home entertainment system that provides audio, video or data content to receiving components, such as a Media Consumer Device (MCD) 132, of the home entertainment system. Further illustrated in FIG. 1 are various examples of Media Consumer Devices (MCD) 132 such as a television 111, and speakers 112, 113, 114 and 115. A Media Consumer Device (MCD) 132 is defined as any element of a home entertainment system that receives audio, video or data content from a Media Source Device (MSD) 131 and plays back audio/video, or delivers data or related content to a consumer. FIG. 1 also shows the radio frequency links between the Media Source Devices (MSDs) 131 and the Media Consumer Devices (MCDs) 132. The examples of radio frequency links provided in FIG. 1 include a video stream 121, and audio streams 122, 123, 124, and 125.

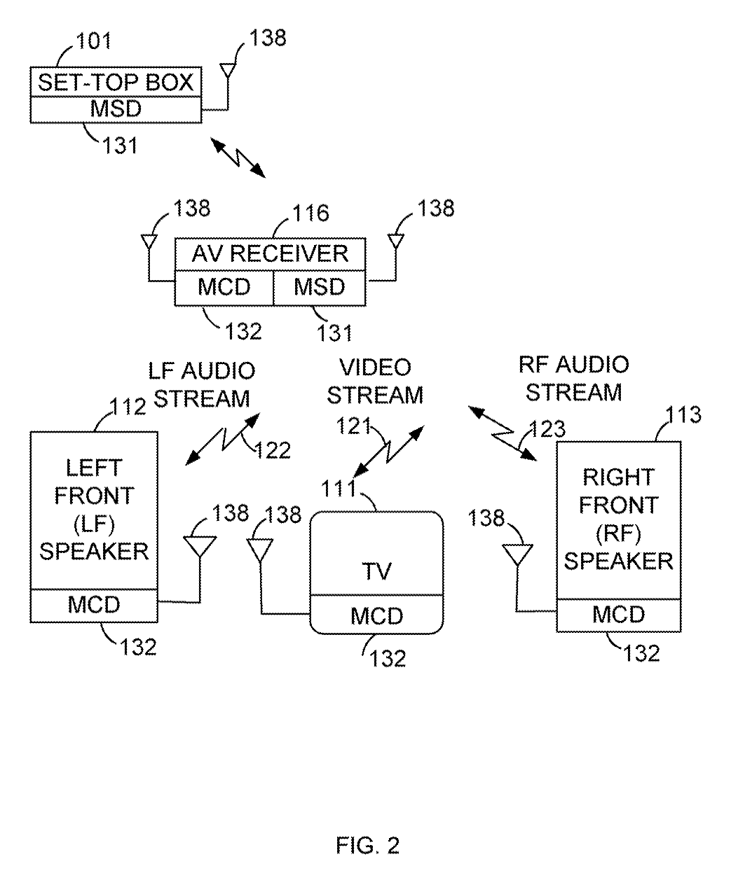

Turning now to FIG. 2, a block diagram of another exemplary wireless home entertainment system is shown. The elements of the wireless home entertainment system depicted in FIG. 2 are provided by way of example, with changes to the elements being expected and known to those skilled in the art. These changes are not meant to be a departure from the spirit and scope of the various embodiments of the present invention as defined herein. In FIG. 2, an Audio-Video (AV) Receiver 116 is portrayed along with a Set-Fop Box (STB) 101, a TV set 111, and two speakers 112 and 113. The Audio-Video (AV) Receiver 116 has both the Media Source Device (MSD) 131 and Media Consumer Device (MCD) 132 functions, such that, one of the functions can be enabled at a time, or both at the same time. The Audio-Video (AV) Receiver 116 can be configured as a Media Consumer Device (MCD) 132 to receive media content from the Set-Top Box 101, or as a Media Source Device (MSD) 131 to distribute media content to the channel speakers 112-113. The configuration can be done by means of a user interface, such as a keypad or control buttons, which are well-understood parts of consumer electronics devices. The Audio-Video (AV) Receiver 116 may, in some embodiments of the present invention, be configured as both a Media Source Device (MSD) 131 and a Media Consumer Device (MCD) 132 at the same time, such that it receives media content from the Set-Top Box (STB) 101 for its own consumption, and in the meantime serves different content to other Media Consumer Devices (MCDs) 132 (e.g., transmitting FM music to speakers), in addition, the Set-Top Box (STB) 101 may wirelessly enable the Audio-Video (AV) Receiver 116 to function as a bridge by performing both the Media Source Device (MSD) 131 and the Media Consumer Device (MCD) 132 functions at the same time, such that the Audio-Video (AV) Receiver 116 receives media content from the Set-Top Box (STB) 101, and turns around to transmit that content to other Media Consumer Devices (MCDs) 132, which may not be in range of wireless communication with the Set-Top Box (STB) 101. The Media Source Device (MSD) 131 normally de-multiplex media content into separate audio and video streams 121, 122 and 123 for the intended Media Consumer Devices (MCD) 132, such that the video stream 121 is delivered to a video Media Consumer Device 132 (such as TV 111) and audio streams 122 and 123 to one or more audio Media Consumer Devices 132 (such as speakers 112 and 113). To effectively to maintain and terminate stream synchronization (e.g., between video and audio streams, or among multiple audio streams), it is preferable in some embodiments of the present invention to have a dominant Media Consumer Device (MCD) 132, such that it continuously broadcasts its current playback position to other Media Consumer Devices (MCD) 132. A video or display device may, for example, be a dominant Media Consumer Device (MCD) 132, and speakers may, for example, be the associated Media Consumer Devices (MCD) 132. In audio applications for a surround sound system, where multiple channel speakers are used to create a good listening environment, a subwoofer may, for example, be a dominant Media Consumer Device (MCD) 132.

In some embodiments of the present invention, the communications path between the Media Source Device (MSD) 131 and the Media Consumer Device (MCD) 132 is a radio frequency communications path. In other embodiments of the present invention, the communications path between the Media Source Device (MSD) 131 and the Media Consumer Device (MCD) 132 is a power line communications path. Power Line Communications (PLC) uses conventional electrical power lines found in a home to distribute data signals such as, for example, audio data signals, between points in the power line communications network. An example of a method and system for media content data distribution and consumption using a power line communications network is United States Patent Application Publication U.S. 2006/0235552 to Constantine N. Manis, Oleg Logvinov and Lawrence F. Durfee entitled “Method And System For Media Content Data Distribution And Consumption”, the entire disclosure of which is incorporated herein by reference. Power Line Communications is also described in Homeplug Standard Brings Networking to the Home, Communications System Design Magazine Vol. 16, No. 12 (December 2000), which is incorporated by reference herein. Improvements to power line communications are also disclosed, for example, in U.S. Pat. No. 7,106,177 to Logvinov et al, and U.S. Patent Application Publication 2006/0242314 to Logvinov et al, the entire disclosures of which are incorporated herein by reference. In other embodiments of the present invention, the communications path between the Media Source Device (MSD) 131 and the Media Consumer Device (MCD) 132 is a data communications path. In other embodiments of the present invention, the communications path between the Media Source Device (MSD) 131 and the Media Consumer Device (MCD) 132 is a telecommunications path. In other embodiments of the present invention, the communications path between the Media Source Device (MSD) 131 and the Media Consumer Device (MCD) 132 is an optical communications path.

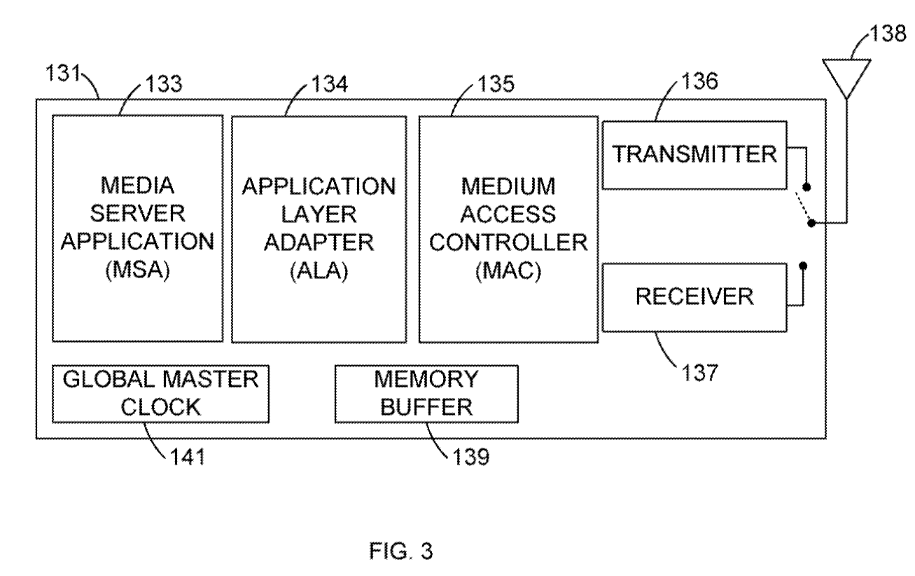

Turning now to FIG. 3, and to the functional architecture diagram of a Media Source Device (MSD) 131 depicted therein, the Media Source Device (MSD) 131 contains a Media Server Application (MBA) 133, which controls and operates a media source component (such as, for example, a digital video recorder 102 or a set-top box 101) of a home entertainment system; an Application Layer Adapter (ALA) 134, which provides a physical/logical interface adapter between the Media Server Application (MSA) 133 and a Medium Access Controller (MAC) 135; a Medium Access Controller (MAC) 135, which allows a device, such as a digital video recorder 102, to access a radio frequency link; a memory buffer 139, which is used for storing data that is exchanged in communications between a Media Source Device (MSD) 131 and a Media Consumer Device (MCD) 132; and a Global Master Clock (GMC) 141, which is used for providing reference timing to the Media Consumer Device (MCD) 132. The Media Source Device (MSD) 131 also contains a radio frequency transmitter 136, a radio frequency receiver 137 and an antenna 138. These radio frequency components are used to provide radio frequency connectivity between the Media Source Device (MSD) 131 and the Media Consumer Device (MCD) 132.

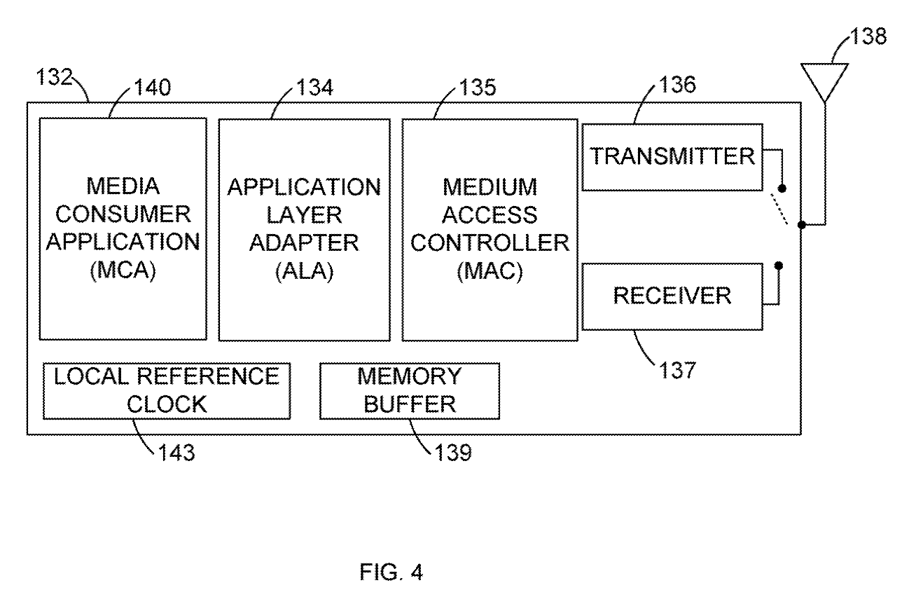

Turning now to FIG. 4, and to the functional architecture diagram of a Media Consumer Device (MCD) 132 depicted therein, the Media Consumer Device (MCD) 132 contains a Media Consumer Application (MCA) 140, which controls a device (such as, for example, a TV 111 or speakers 112, 113, 114 or 115, not shown in FIG. 4) to render and playback received media content; an Application Layer Adapter (ALA) 134, which is a physical/logical interface adapter between the Media Consumer Application (MCA) 140 and a Medium Access Controller (MAC) 135; a Medium Access Controller (MAC) 135, which allows a device, such as a TV 111, to access a radio frequency link; a memory buffer 139, which has a queue structure for temporarily storing indexed stream data that is exchanged in communication between a Media Source Device (MSD) 131 and a Media Consumer Device (MCD) 132, and whose size may be determined by variables such as, for example, stream peak bit rate and the length of the video data to be stored temporarily. For example, the Media Consumer Device (MCD) 132 may need to hold 5 seconds of video data before a rendering process can start. For an MPEG-2 encoded video, the maximum bit rate is about 6 Mbps (mega bits per second), and the memory buffer 139 should be at least 4 megabytes (Mbytes). The Media Consumer Device (MCD) 132 also contains a radio frequency transmitter 136, a radio frequency receiver 137 arid an antenna 138. These radio frequency components are used to provide radio frequency connectivity between the Media Source Device (MSD) 131 and the Media Consumer Device (MCD) 132. The Media Consumer Device (MCD) 132 also contains a Local Reference Clock (LRC) 143. A Local Reference Clock (LRC) 143 provides timing for communications and rendering processes and is synchronized with the Global Master Clock (GMC) 141 in the Media Source Device (MSD) 131.

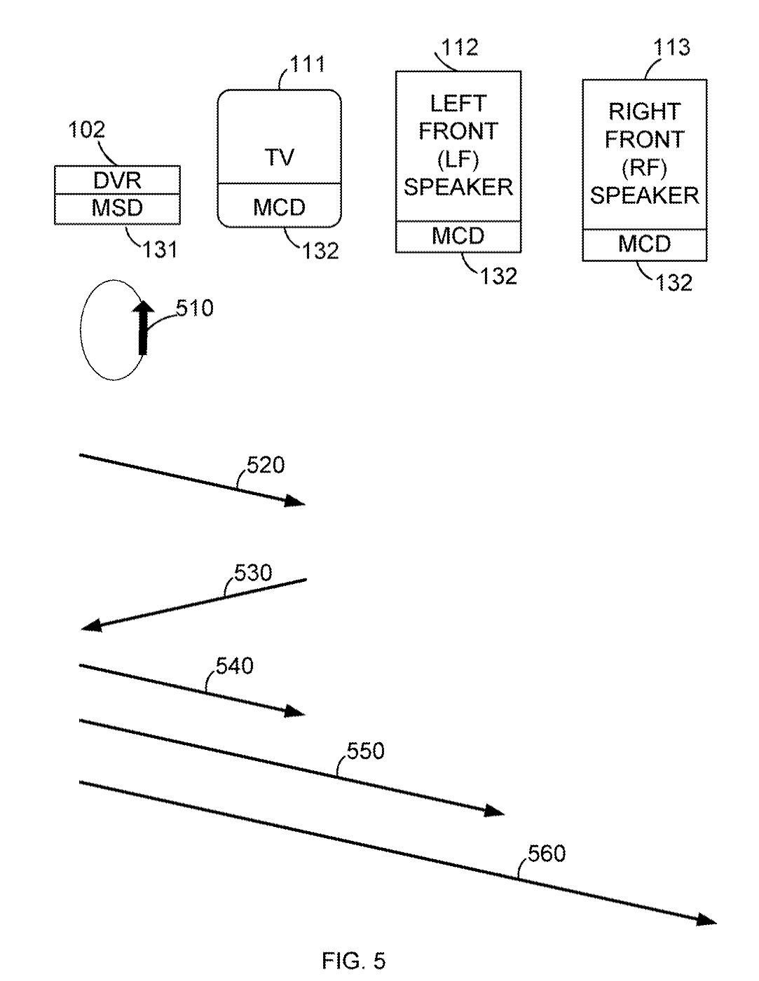

Referring now to FIG. 5, an example of starting up an audio-video application, such as watching a movie stored in a digital video recorder (DVR) 102 wirelessly, is shown. The Media Server Application (MSA) 133 of the Media Source Device (MSD) 131 starts a device discovery process as indicated by arrow 510 and communicates with the TV 111 by sending its media list as indicated by arrow 520, which contains a list of all stored movies. The TV 111 processes the media list and displays the list of available movies to the user, who can then select a movie to watch from the list. The user may enable the audio multicast function to experience the surround sound effect of the home theater system. When enabled, the audio multicast allows the Media Consumer Device (MCD) 132 to instruct, the Media Source Device (MSD) 131 to de-multiplex the selected media content into separate video and audio streams, where the video stream will be sent to a display device such as the TV 111 and the audio streams will then be sent to separate speakers 112 and 113. As indicated by arrow 530, the TV 111 sends a media selection, along with the audio multicast selection, to the DVR 102. Upon receiving the media and audio multicast selection command, the DVR 102 begins streaming video data to the TV 111 as indicated by arrow 540, and audio data to both the left-front and right-front channel speakers 112 and 113 respectively, as indicated by arrows 550 and 560.

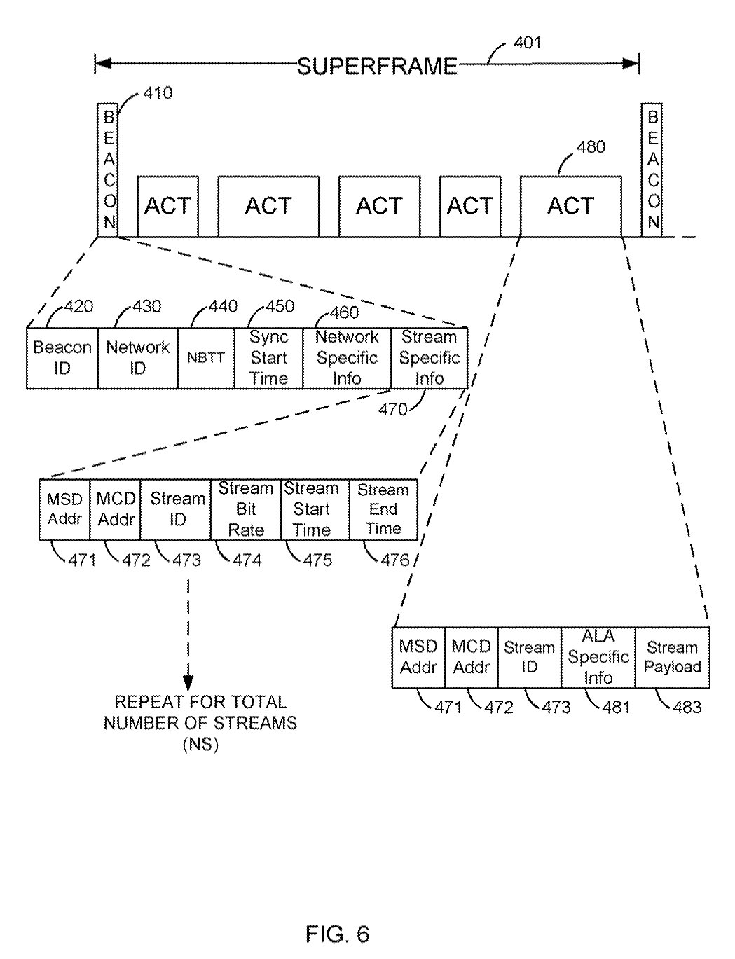

Referring now to FIG. 6, an example of a data frame structure is depicted. Due to the isochronous nature of the application, where guarantee of data delivery in a fixed period of time is required to maintain an acceptable level of quality of service (QoS), the system uses the Time Division Multiple Access (TDMA) based network protocol to deliver media information. In a Time Division Multiple Access (TDMA) system, a network controller (usually the Media Source Device 131) establishes a logical communication channel with one or more Media Consumer Devices (MCD) 132. The logical communication channel, also known as the superframe 401, is repetitive in time and bounded by a synchronous control signal. The synchronous control signal, often referred to as the beacon 410, contains a number of network operation and control parameters and information, and ensures that the superframe 410 is time synchronized. Following the beacon 410, the Time Division Multiple Access (TDMA) technique allows one or more time slots to be allocated within the superframe 401 period. Each time slot, also referred to as the Allocated Channel lime (ACT) 480, allows data to be exchanged between the Media Source Device (MSD) 131 and the Media Consumer Device (MCD) 132. The same amount (i.e., duration) of Allocated Channel Time (ACT) is repeated at a fixed, predefined interval, such that the application can precisely predict the time and the amount of data that will be delivered, thereby meeting the QoS level. To improve the probability of simultaneous arrival of the isochronous streams of audio, video or data content sent between a Media Source Device (MSD) 131 and a Media Consumer Device (MCD) 132, such as illustrated previously in FIG. 1, the following techniques are used:
First, the Media Source Device (MSD) 131 periodically transmits synchronous control signaling such as a beacon 410 that contains the fields of the Beacon Identification (Sequence) Number (Beacon ID) 420, the Network Identification Number (Network ID) 430, the Next Beacon Transmission Time (NBTT) 440, the Synchronization Start Time 450, the Network Specific Information 460, and the Stream Specific Information 470. The Next Beacon Transmission Time (NBTT) 440 is generally an offset from the time when the current beacon was transmitted. The Network Specific Information field 460 includes the time generated by the Global Reference Clock (GMC) 141 in the Media Source Device (MSD) 131. The field of the Stream Specific Information 470 comprises specific information for a number of streams to be transported during the current superframe 401 cycle, a superframe 401 being defined as the time interval from the beginning of one beacon until the beginning of the next beacon. The information for each specific stream contains the originator (i.e., Media Source Device 131) and destination (i.e., Media Consumer Device 132) information of the streams (MSD Addr 471 and MCD Addr 472), the specific Stream Identification (or sequence) Number (Stream ID) 473, the Stream Bit Rate 474, the Stream Start Time 475 and the Stream End Time 476.
Second, following the beacon transmission, the Media Source Device (MSD) 131 transmits the properly indexed streams to their respective Media Consumer Devices (MCDs) 132 at the stream transmission start times as indicated by the Stream Start Time 475 in the designated network time slots (or allocated channel time, ACT 480). For each stream transmitted in its designated Allocated Channel Time (ACT) 480, the information contained herein includes the originator (i.e., Media Source Device or MSD 131) and destination (i.e., media consumer device or MCD 132) information of the streams (MSD Addr 471 and MCD Addr 472), the specific Stream Identification (Or Sequence) Number (Stream ID) 473, the Application Layer Adapter (ALA) 134 Specific Information (ALA Specific Info) 481 and Stream Payload data 483.
Third, an Allocated Channel Time (ACT) 480 can be designated as either a Forward Allocated Channel Time (FACT) or Reverse Allocated Channel Time (RACT). The Forward Allocated Channel Time (FACT) is used for a Media Source Device (MSD) 131 to transmit media streams to a Media Consumer Device (MCD) 132, whereas the Reverse Allocated Channel Time (RACT) may be used by the Media Consumer Device (MCD) 132 to send a form of control signals such as high-level acknowledgment or flow control signal to the Media Source Device (MSD) 131. An Allocated Channel Time (ACT) reserved for content streaming from a specified Media Source Device (MSD) 131 to a specified Media Consumer Device (MCD) 132 is repeated at the same instant in every superframe 401 until the stream is terminated in order to ensure the QoS (Quality of Service) level is guaranteed, in which QoS is defined as the cumulative effect on user satisfaction of all imperfections affecting the content distribution service, such imperfections may, for example, include delay, dropped packets, jitter, error, and out-of-order delivery.
Fourth, the system employs robust flow control and error detection and correction mechanisms, which are the functions of the Application Layer Adapter 154 (ALA), such that if the Media Consumer Device (MCD) 132 does not receive the intended stream properly, it will request retransmission of all or part of the stream from the Media Source Device (MSD) 131.

### The table below defines terms used in the data frame structure depicted in FIG. 6:

| | |
|---|---|
| Beacon | A form of synchronous control signals used to control and |
| | synchronize the operation of a communication network. |
| ACT | Allocated Channel Time, a designated time slot in a TDMA-based |
| | network reserved for communication between specified source and |
| | destination network nodes. |
| ALA Specific Info | Specific information required by the Application Layer Adapter |
| | (ALA) to coordinate and process the stream information. |
| Stream Payload | Actual stream data generated by the Media Source Device (MSD) |
| | and received by the Media Consumer Device (MCD) for |
| | presentation to the consumer. |
| Beacon ID | A unique sequence number used to identify a beacon signal being |
| | transmitted by a source to a destination in a communication system. |
| Network ID | A unique number to identify a particular communication network. |
| NBTT | Next Beacon Transmission Time, used to indicate the time instance |
| | for transmitting the next beacon. |
| Sync Start Time | A form of numeric counter used to indicate to the Media Consumer |
| | Devices (MCDs) to start the synchronization process when it |
| | decrements to zero. |
| Network Specific | Specific information pertaining to the operation of a communication |
| Info | network. |
| Stream Specific Info | Specific information pertaining to individual streams being |
| | transported in the current superframe cycle. |
| MSD Addr | A logical network address used by the Media Source Device (MSD) |
| | for communication in a network. |
| MCD Addr | A logical network address used by the Media Consumer Device |
| | (MCD) for communication in a network. |
| Stream ID | A unique sequence number used to identify a data stream being |
| | transported from a source to a destination in a network. |
| Stream Bit Rate | A metric used to represent the number of information bits passed in |
| | a data stream from one point to another in a given time. |
| Stream Start Time | An instant at which the transfer of a stream starts. |
| Stream End Time | An instant at which the transfer of a stream ends. |

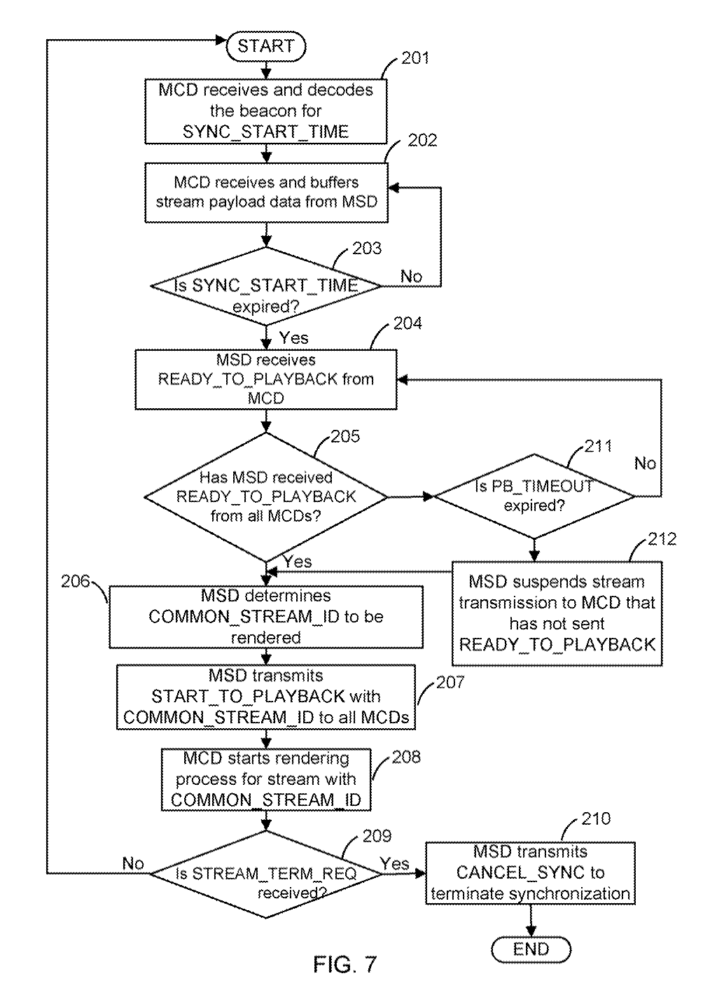

Referring now to FIG. 7, a flow chart depicting the process of establishing and terminating synchronization is shown. To establish synchronization of the received isochronous streams at different Media Consumer Devices (MCDs) 132, the following steps are taken;
First, in block 201 each Media Consumer Device (MCD) 132 decodes the information in the beacon 410 and determines its synchronization start time (SYNC_START_TIME) according to the information in the Synchronization Start Time field 450. The synchronization start time is indicated by the number of elapsed beacon transmissions from the current beacon sequence number (or Beacon ID 420). It is essentially a count down to when each Media Consumer Device (MCD) 132 can start the rendering process of its received stream data 483, a rendering process, as used herein, being a content encoding/decoding, multiplexing (if any) and playback process. The minimum value of SYNC_START_TIME is calculated by rounding up to the nearest whole frame or superframe to accommodate the amount of time needed by the slowest audio or video codec for processing, where a codec is an encoder/decoder function present in the Media Consumer Application (MCA) 140 and any extra time it may take the stream to successfully arrive at the Media Consumer Device (MCD) 132. A superframe 401 is defined as the time interval from the beginning of one beacon until the beginning of the next beacon. A codec in the Media Consumer Device (MCD) 132 usually needs to buffer some specific amount of data before it can start the rendering process, and because consumer platforms may differ in design or resources, or use different types of codec, it may take different amounts of time to start the codec and begin playback. Therefore, an adequate “count-down” number must be used to make sure that all of the codecs (different audio and video codecs as used in different Media Consumer Devices 132) are ready at the same time. The selection of a SYNC_START_TIME value depends on several factors, such as the type of content (audio or video) being streamed, the format of content (e.g., analog, digital or pre-encoded), the throughput requirement of content (i.e., bit rate in number of bits per second), the size of memory buffer 139 in the Media Consumer Device (MCD) 132, etc. In some applications, the Media Source Device (MSD) 131 may automatically discover and keep track of the capabilities of associated Media Consumer Devices (MCDs), and use the obtained information to determine the SYNC_START_TIME value.
Second, in block 202, each Media Consumer Device (MCD) 132 receives the desired isochronous stream and stores it in a temporary buffer space 139 indexed according to the received stream sequence number (i.e., Stream ID 473). The memory buffer 139 has a queue structure, where data with a low Stream ID 473 is placed in the front of the queue and is processed by the Media Consumer Application (MCA) 140 before stream data with higher Stream Ids 473. Because stream data may arrive at the Media Consumer Device (MCD) 132 out of sequence, which may be caused by the effect of flow control or retransmissions, some logic is contained in the memory buffer 139 for organizing the received stream data and storing the data in a correct sequence.
Third, each Media Consumer Device (MCD) 132 continues to receive beacon(s) 410 from the Media Source Device (MSD) 131 and perhaps more stream data, which shall be stored in temporary buffer spaces 139 and indexed accordingly. If the Media Consumer Device (MCD) 132 detects a potential buffer overrun problem (i.e., more data than the size of the buffer memory 139) because, for example, the stream data is being received faster than they are released to the rendering process, it will, in some embodiments of the present invention, invoke a flow control mechanism by sending a flow control signal to the Media Source Device (MSD) 131 in the Reverse Allocated Channel Time (RACT).
Fourth, in block 203, at the scheduled synchronization start time (at expiration of SYNC_START_TIME), each Media Consumer Device (MCD) 132, upon receiving the current beacon (i.e., SYNC_START_BEACON), transmits to the Media Source Device (MSD) 131 a READY_TO_PLAYBACK signal as in block 204, which contains the sequence number(s) of the stream (i.e., Stream ID 473) that will be rendered. For example, if a Media Consumer Device (MCD) 132 has 10 streams (with Stream ID 40 to 49) properly stored in its memory buffer 139, it will include Stream ID numbers 40 to 49 in the READY_TO_PLAYBACK signal. Another Media Consumer Device (MCD) 132 may have only 8 streams (Stream ID numbers 40 to 47) in its memory buffer 139, therefore in this example its READY_TO_PLAYBACK signal will only include these Stream ID numbers.
Fifth, if the Media Consumer Device (MCD) 132 missed the SYNC_START_BEACON at its scheduled time instance, it shall transmit the READY_TO_PLAYBACK signal to the Media Source Device (MSD) 131 upon receiving the next beacon.
Sixth, in block 205, the Media Source Device (MSD) 131 verities whether the READY_TO_PLAYBACK notifications have been received from all the desired Media Consumer Devices (MCDs) 132; if they have not been received, the Media Source Device (MSD) 131 awaits the READY_TO_PLAYBACK signal to be received from ail the desired media consumers and waits for the PB_TIMEOUT to expire, as in block 205.
Seventh, when the Media Source Device (MSD) 131 has received the READY_TO_PLAYBACK signal from all the desired Media Consumer Devices (MCDs) 132, it compares the stream sequence numbers (Stream ID) 473 to be rendered in all the READY_TO_PLAYBACK signals and finds the least common denominator stream sequence numbers (COMMON_STREAM_ID) as in block 206. As in the previous example, where the READY_TO_PLAYBACK signal from one Media Consumer Device (MCD) 132 contains Stream ID numbers 40 to 49, while the other contains Stream ID 40 to 47, the Media Source Device (MSD) 131 will use Stream ID number 40 to 47 as the COMMON_STREAM_ID, which may be represented by a bit map (e.g., bits 40 to 47 are flagged). This guarantees that only the stream data with the same Stream ID numbers are released to the rendering process.
Eighth, the Media Source Device (MSD) 131 transmits the prioritized START_TO_PLAYBACK signal, which contains the COMMON_STREAM_ID to be rendered, to all the desired Media Consumer Devices (MCDs) 132 in a broadcast or multicast manner as in block 207. The START_TO_PLAYBACK signal can also be included in the Network Specific Information field 460 of the next beacon 410 to be transmitted.
Ninth, as in block 208, each Media Consumer Device (MCD) 132 receives the START_TO_PLAYBACK signal and starts the rendering and playing-back process for the streams indicated by the COMMON_STREAM_ID. The matched streams are passed to the Media Consumer Application (MCA) 140 and de-queued from the memory buffer 139.
Tenth, the Media Consumer Device (MCD) 132 continues to retain streams that were not designated in the START_TO_PLAYBACK signal. The streams are retained in the buffers 139 until the next synchronization time or when the media devices (MSD 131 or MCD 132) terminate the streams.

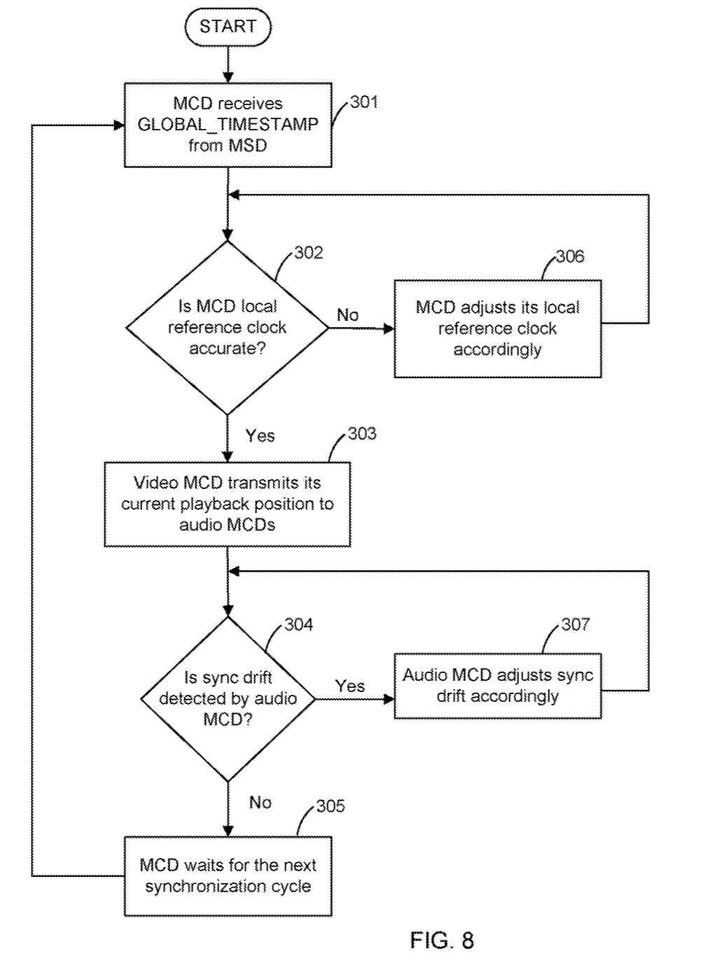

Referring now to FIG. 8, a flow chart depicting the process of maintaining synchronization is depicted. In order to maintain synchronization continuously, the following steps are taken;
First, to avoid or minimize synchronization drift, where deviation from a synchronized event starts to manifest, the Media Source Device (MSD) 131 periodically transmits the GLOBAL_TIMESTAMP signal derived from a Global Master Clock (GMC) 141 to all the desired Media Consumer Devices (MCDs) 132 in a broadcast or multicast manner (as a network management command) in block 301.
Second, each Media Consumer Device (MCD) 132 receives the GLOBAL_TIMESTAMP signal from the Media Source Device (MSD) 131 and, along with the beacon time (i.e., the start of beacon transmission time), determines whether its Local Reference Clock 143 is accurate in block 302. If an inaccuracy is detected, the Media Consumer Device (MCD) 132 properly adjusts its Local Reference Clock 143 in block 306 for the start of the rendering process.
Third, in block 303, a Media Consumer Device (MCD) 132 that has been designated as a video component such as a TV 111 periodically transmits its current playback position, which is represented by the Stream ID 473 for the stream data that is being rendered and its current time instant, to other Media Consumer Devices (MCDs) 132 designated as audio components 112-115 to ensure a high level of synchronization in a simulcast output, a simulcast being an output of stream content from multiple Media Consumer Devices (MCDs) 132. Often times the video source is considered the reference for the system because of its dominance in the home entertainment environment.
Fourth, the audio Media Consumer Device (MCD) 132 determines whether a synchronization drift is present in block 304. If a synchronization drift is detected to be above a predefined threshold by a comparison of playback positions, the audio Media Consumer Device (MCD) 132 adjusts its playback position accordingly to synchronize with the video playback position in block 307. If there is a mismatched playback, position between the video Media Consumer Device (e.g., TV 111) and the audio Media Consumer Device (e.g., Left Front Speaker 112), where normally the playback position of the audio Media Consumer Device is ahead of the video Media Consumer Device because of less audio information to be rendered, the audio Media Consumer Device may temporarily suspend the rendering process until it has reached the same playback position as the video Media Consumer Device. If no synchronization drift is detected in block 304, the Media Consumer Device (MCD) 132 then waits for the next synchronization cycle. For the remaining steps, reference will be made to FIG. 7 and the flowchart depicted therein.
Fifth, if the READY_TO_PLAYBACK signal is not received from a desired Media Consumer Device (MCD) 132 after a predefined period of time (i.e., PB_TIMEOUT) in block 211, the Media Source Device (MSD) 131 may temporarily suspend the stream transmission to that Media Consumer Device (MCD) 132 and attempt to resynchronize at a later time in block 212. For example, if an audio Media Consumer Device (MCD) 132 (such as a speaker) is experiencing some internal problems, the Media Source Device (MSD) 131 may decide to stop transmitting audio streams to it for a period of time until it is notified by that Media Consumer Device (MCD) 132 that it is ready to receive data again. During this time, the video and other audio Media Consumer Devices (MCDs) 132 can continue their respective synchronization and rendering processes. If so equipped, the Media Source Device (MSD) 131 may also choose to notify the user of the problem associated with the audio Media Consumer Device 132 by means of transmitting on-screen messages to the video Media Consumer Device (MCD) 131.
Sixth, in block 209, when the transmission of one or more streams are purposely terminated by means of a stream termination request (STREAM_TERM_REQ) from either the Media Source Device (MSD) 131 or the Media Consumer Device (MCD) 132, the Media Source Device (MSD) 131 decides whether or not to continue to maintain synchronization. A stream termination request (STREAM_TERM_REQ) allows either the Media Source Device (MSD) 131 or the Media Consumer Device (MCD) 132 to request a termination of streams in session. For example, if the “stop” button is depressed on a DVR 102, the DVR 102, functioning as a Media Source Device (MSD) 131, transmits a stream termination request to all the intended Media Consumer Devices (MCD) 132. Upon receiving the request, the Media Consumer Device immediately stops the rendering process, de-queues all the pending streams from the memory buffer 139, and may notify the user of the termination status, hi some situations, the Media Consumer Device (MCD) 132, upon receiving the termination request, may need to send back an acknowledgment to the Media Source Device (MSD) 131. If the stream is terminated for a video Media Consumer Device, the Media Source Device 131 may stop audio synchronization immediately and de-queue all audio and video streams from its transmission queue. The Media Source Device may still continue to transmit streams to the video Media Consumer Device even if stream termination has been made to the audio Media Consumer Device.
Seventh, if synchronization no longer needs to be maintained (such as when the audio Media Consumer Devices (MCDs) 132 are switching off), the Media Source Device (MSD) 131 transmits a CANCEL_SYNC signal to the other Media Consumer Devices (MCD) 132 that still maintain active streams in block 210. The CANCEL_SYNC signal is often in response to the stream-termination command and is only initiated by the Media Source Device (MSD) 131. An acknowledgment from the Media Consumer Device (MCD) 132 is expected.
Eighth, upon receiving the CANCEL_SYNC signal from the Media Source Device (MSD) 131, each Media Consumer Device (MCD) 132 starts (or reverts to) the normal rendering process without the need to count beacons and wait for the START_TO_PLAYBACK signal from the Media Source Device (MSD) 131. The Media Consumer Device (MCD) 132 under such circumstances may also choose to stop the rendering process completely if so desired. For example, when the stereo speakers (left front and right front) 112 and 113 are instructed to cancel their respective media synchronization with the TV 111 because “lip sync” from the speakers is no longer needed, the speakers may switch off their rendering process as well.
Ninth, when the transmission of the dominant stream (i.e., the video stream 121) is terminated, the Media Source Device (MSD) 131 terminates the other associated streams (for example, the audio streams 122-125) by transmitting the SYNC_STOP signal, which includes an instruction for terminating streams, to the desired Media Consumer Devices (MCDs) 132; and
Tenth, the Media Consumer Device (MCD) 132, upon receiving the SYNC_STOP signal, immediately terminates the rendering and playing-back process and reverts to idle operation.

### The table below defines terms used in the flowchart depicted in FIG. 7:

| | |
|---|---|
| SYNC_START_TIME | A time instance derived from a beacon signal by the Media |
| | Consumer Device (MCD) to start the synchronization process. |
| READY_TO_PLAYBACK | A form of control signals used by the Media Consumer Device |
| | (MCD) to notify the Media Source Device of its readiness to |
| | start the rendering process. |
| PB_TIMEOUT | A time interval used by the Media Source Device (MSD) to |
| | determine whether the READY_TO_PLAYBACK signal has |
| | been received from a desired Media Consumer Device (MCD). |
| COMMON_STREAM_ID | A common stream sequence number derived at the Media |
| | Source Device (MSD) to represent the stream to be processed |
| | and rendered by individual Media Consumer Devices (MCDs). |
| START_TO_PLAYBACK | A form of control signals used the Media Source Device |
| | (MSD) to inform individual Media Consumer Devices (MCDs) |
| | to start rendering the specified stream. |
| GLOBAL_TIMESTAMP | A form of control signals used by the Media Source Devices |
| | (MSD) to set a reference time for the synchronization and |
| | rendering processes. |
| STREAM_TERM_REQ | A form of control signals used by the Media Source Device |
| | (MSD) to notify the Media Consumer Device (MCD), or vice |
| | versa, as a request to terminate a stream. |
| CANCEL_SYNC | A form of control signals used by the Media Source Device |
| | (MSD) to notify a specified Media Consumer Device (MCD) |
| | that stream synchronization no longer needs to be maintained. |
| SYNC_SHOP | A form of control signals used by the Media Source Device |
| | (MSD) to notify all Media Consumer Devices (MCDs) to stop |
| | synchronization and rendering processes. |

In some embodiments of the present invention, a method for increasing the probability of isochronous streams arriving simultaneously at their respective destinations includes the steps of:
1. a Media Source Device (MSD) 131 periodically transmitting a synchronous control signal to synchronize a communication process between the Media Source Device 131 and a Media Consumer Device 132;
2. transmitting isochronous streams from the Media Source Device (MSD) 131 to their respective destinations using stream transmission start times of designated time slots; and
3. invoking flow control and error detection/correction mechanisms to increase the reliability of the data arriving at its proper destination.

In some embodiments of the present invention, a method for establishing synchronization of isochronous streams upon arriving at their respective destinations includes the steps of:
1. a Media Consumer Device (MCD) 132 decoding information in a received synchronous control signal to determine synchronization start time using a synchronous control signal sequence number;
2. receiving a desired isochronous stream in a Media Consumer Device (MCD) 132 and storing the isochronous stream in an indexed temporary buffer space 139;
3. continuing to receive synchronous control signals in the Media Consumer Device (MCD) 132 and more streams from a Media Source Device (MSD) 131 and storing desired streams in temporary buffer space 139 indexed accordingly;
4. notifying the Media Source Device (MSD) 131 of its readiness for rendering a stored stream when the Media Consumer Device (MCD) 132 receives the synchronous control signal with a designated sequence number;
5. the Media Consumer Device (MCD) 132, having missed the synchronous control signal with the designated sequence number, notifying the Media Source Device (MSD) 131 of its readiness for rendering the stored stream upon receiving the next synchronous control signal;
6. the Media Source Device (MSD) 131 verifying whether or not the notification signal has been received from all the desired Media Consumer Devices (MCDs) 132;
7. the Media Source Device (MSD) 131 comparing the stream sequence numbers in the received notification signals and finding the least common denominator stream sequence number;
8. the Media Source Device (MSD) 131 transmitting a prioritized start signal to all the desired Media Consumer Devices (MCDs) 132 in a broadcast or multicast manner, indicating the designated stream for the rendering process;
9. the Media Consumer Device (MCD) 132, upon receiving the prioritized start signal, starting the rendering and playing-back process for the designated stream; and
10. the Media Consumer Device (MCD) 132 continuing to maintain streams stored in the buffer 139 until the next synchronization time.

In some embodiments of the present, invention, controls for maintaining synchronization continuously include the steps of:
1. the Media Source Device (MSD) 131 transmitting a global timestamp signal to all the desired Media Consumer Devices (MCDs) 132 in a broadcast or multicast manner in an attempt to minimize synchronization drift;
2. the Media Consumer Device (MCD) 132, upon receiving the global timestamp and along with the beacon time, properly adjusting its local clock reference for the start of the rendering process;
3. the Media Consumer Device (MCD) 132 designated as the video consumer such as TV 111 periodically transmitting its playback position to other Media Consumer Devices (MCDs) 132 designated as the audio consumers such as speakers 112-115 to ensure a high level of synchronization in the simulcast output;
4. an audio Media Consumer Device (MCD) 132, upon detecting a synchronization drift, quickly adjusting its playback position to re-synchronize with the video playback position;
5. the Media Source Device (MSD) 131 determining whether or not to terminate the stream transmission to the Media Consumer Device (MCD) 132 that has not been heard for a period of time;
6. the Media Source Device (MSD) 131 determining whether or not to continue to maintain synchronization after the transmission of one or more streams have been terminated;
7. the Media Source Device (MSD) 131 transmitting a cancel-synchronization signal to the desired Media Consumer Devices (MCDs) 132 that still maintain active streams when synchronization is no longer needed;
8. the Media Consumer Device (MCD) 132, upon receiving the cancel-synchronization signal, reverting to the normal rendering process without invoking the synchronization process;
9. the Media Source Device (MSD) 131 terminating non-dominant streams, when the transmission of the dominant stream has been terminated, by transmitting a stop signal to the desired Media Consumer Devices (MCDs) 132;
10. the Media Consumer Device (MCD) 132, upon receiving the stop signal from the Media Source Device (MSD) 131, immediately terminating the rendering and playing-back process and reverting to idle state.

It is, therefore, apparent that there has been provided, in accordance with the various objects of the present invention, a system and method for establishing and maintaining synchronization of isochronous audio and video information streams in wireless multimedia applications.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification and the claims herein.

What is claimed is:

1. A system for establishing and maintaining synchronization of isochronous audio, video, and data information streams in wireless multimedia applications, the system comprising:
a media source device capable of sending multimedia content;
a media consumer device capable of receiving said multimedia content;
control signals that are exchanged between said media source device and said media consumer device; and
an algorithm that uses said control signals to synchronize isochronous video and audio streams that pass between said media source device and said media consumer device.

2. The system according to claim 1, wherein the media source device is an electronic device that hosts and wirelessly provides multimedia content information to a media consumer device.

3. The system according to claim 1, wherein the media consumer device is an electronic device capable of rendering and playing back wirelessly received media information from said media source device.

4. The system according to claim 1, wherein the media source device and the media consumer device are a single electronic device.

5. The system according to claim 1, wherein the wireless multimedia application uses a time division multiple access networking protocol.

6. The system according to claim 1, wherein the wireless multimedia application is isochronous in nature.

7. A media source device comprising:
a media application;
an application layer adapter operatively coupled to the media application;
a medium access controller adapted to interface with the application layer adapter and a radio frequency transmitter-receiver;
and a radio frequency transmitter-receiver operatively coupled to said media source device.

8. The media source device of claim 7 wherein the media application is a media source application.

9. A media consumer device comprising:
a media application;
an application layer adapter operatively coupled to the media application;
a medium access controller adapted to interface with the application layer adapter and a radio frequency transmitter-receiver;
and a radio frequency transmitter-receiver operatively coupled to said media consumer device.

10. The media consumer device of claim 9 wherein the media application is a media consumer application.

11. A method for establishing and maintaining synchronization of isochronous audio and video information streams, the method comprising the steps of:
starting up and connecting a media source device to a media consumer device;
delivering media information from said media source device to said media consumer device;
starting audio-video synchronization between an audio media consumer device and a video media consumer device; and
terminating audio-video synchronization between said audio media consumer device and said video media consumer device.

12. The method according to claim 11, further including the steps of:
periodically transmitting a control signal beacon from a media source device to synchronize the communication process;
transmitting isochronous streams from a media source device to their respective destinations using stream transmission start times of designated time slots; and
invoking flow control and error detection-correction mechanisms to improve reliability.

13. The method according to claim 11, further including the steps of:
decoding information by a media consumer device in a received synchronous control signal to determine synchronization start time using a synchronous control signal sequence number;
receiving a desired isochronous stream in a media consumer device and storing the isochronous stream in an indexed temporary buffer space;
continuing to receive synchronous control signals in the media consumer device and streams from the media source device and storing desired streams in temporary buffer space;
notifying the media source device of readiness for rendering a stored stream when the media consumer device receives a synchronous control signal with a designated sequence number;
notifying the media source device of readiness for rendering the stored stream upon receiving the next beacon when the media consumer device misses the beacon with the designated sequence number;
verifying if the notification signal has been received from all designated media consumer devices by the media source device;
comparing the stream sequence numbers in the received notification signals and finding the least common denominator stream sequence number by the media source device;
transmitting a prioritized start signal to all designated media consumer devices in a broadcast or multicast manner, indicating the designated stream for the rendering process by the media source device;
starting the rendering and playing-back process for the designated stream by the media consumer device upon receiving a prioritized start signal; and
continuing to maintain streams stored in buffer until the next synchronization time by the media consumer device.

14. The method according to claim 11 further including the steps of:
transmitting a global timestamp signal to all designated media consumer devices in a broadcast manner by the media source device to minimize synchronization drift;
properly adjusting the media consumer device local clock reference for start of the rendering process upon receipt of the global timestamp and the synchronous control time by the media consumer device;
periodically transmitting the video media consumer device's playback position by the video media consumer device to other audio media consumer devices to ensure a high level of synchronization in simulcast output;
adjusting an audio media consumer device's playback position upon detecting a synchronization drift to re-synchronize with the video playback position;
determining whether or not to terminate stream transmission from the media source device to a media consumer device that has been silent for a period of time;
determining whether or not to continue to maintain synchronization by the media source device after the media source device has terminated the transmission of one or more streams;
transmitting a cancel synchronization signal by the media source device to designated media consumer devices that still maintain active streams when synchronization is no longer needed;
reverting to the normal rendering process by a media consumer device without invoking the synchronization procedure upon receiving the cancel synchronization signal;
terminating non-dominant streams by the media source device when the transmission of the dominant stream by the media source device has been terminated by transmitting a stop signal to designated media consumer devices; and
terminating the rendering and playing-back processes and reverting to idle state by a media consumer device upon receiving the stop signal from the media source device.

15. A system for establishing and maintaining synchronization of isochronous audio, video, and data information streams in multimedia applications, the system comprising:
a media source device capable of sending multimedia content;
a media consumer device capable of receiving said multimedia content;
a communications path between said media source device and said media consumer device;
control signals that are exchanged between said media source device and said media consumer device; and
an algorithm that uses said control signals to synchronize isochronous video and audio streams that pass between said media source device and said media consumer device.

16. The system according to claim 15, wherein the communications path is a power line communications path.

17. The system according to claim 15, wherein the communications path is a data communications path.

18. The system according to claim 15, wherein the communications path is a telecommunications path.

19. The system according to claim 15, wherein the communications path is a radio frequency communications path.

20. The system according to claim 15, wherein the communications path is an optical communications path.
